(19) United States
(12) Patent Application Publication
(10) Pub. No.: US 2022/0173504 A1
(43) Pub. Date: Jun. 2, 2022

(54) BASE STATION ANTENNAS HAVING ARRAYS WITH BOTH MECHANICAL UPTILT AND ELECTRONIC DOWNTILT

(71) Applicant: CommScope Technologies LLC, Hickory, NC (US)

(72) Inventors: Louis J. MEYER, Shady Shores, TX (US); Ray K. BUTLER, Allen, TX (US); Martin L. ZIMMERMAN, Chicago, IL (US)

(21) Appl. No.: 17/434,639

(22) PCT Filed: Jan. 29, 2020
(86) PCT No.: PCT/US2020/015573

§ 371 Date: Aug. 27, 2021

Related U.S. Application Data
(60) Provisional application No. 62/818,222, filed on Mar. 14, 2019.

(51) Int. Cl. H01Q 1/24; H01Q 19/10; H01Q 21/06; H01Q 21/24; H01Q 3/01; H01Q 3/06; H01Q 3/32; H01Q 3/34

(52) U.S. Cl. CPC H01Q 1/246; H01Q 19/108; H01Q 21/062; H01Q 3/34; H01Q 3/01; H01Q 3/06; H01Q 3/32; H01Q 21/24

(57) ABSTRACT

Base station antennas a reflector, an RF port, an array of radiating elements, where each radiating element is mounted to extend forwardly from the reflector and mechanically uptilted with respect to the reflector, and a feed network coupled between the RF port and the array of radiating elements. The feed network includes a plurality of delay elements that are configured to impart a fixed electronic downtilt to a radiation pattern generated by the array of radiating elements in response to an RF signal input at the RF port.

### CROSS-REFERENCE TO RELATED APPLICATION

The present application claims priority to U.S. Provisional Application Ser. No. 62/818,222, filed Mar. 14, 2019, the entire content of which is incorporated herein by reference as if set forth fully herein.

### FIELD OF THE INVENTION

The present invention relates to communication systems and, in particular, to base station antennas for cellular communications systems.

### BACKGROUND

Cellular communications systems are used to provide wireless communications to fixed and mobile subscribers (herein “users”). A cellular communications system may include a plurality of base stations that each provide wireless cellular service for a specified coverage area that is referred to as a “cell.” Each base station may include one or more base station antennas that are used to transmit radio frequency (“RF”) signals to, and receive RF signals from, users that are within the cell served by the base station. Cells are often divided into multiple “sectors,” and separate base station antennas provide cellular service to each sector. For example, in a “three sector” configuration, a cell is divided into three 120° sectors in the azimuth plane, and the base station includes three base station antennas that provide coverage to the three respective sectors. The azimuth plane refers to a horizontal plane that bisects the base station antenna that is parallel to the plane defined by the horizon, and the elevation plane refers to a plane extending along the mechanical boresight pointing direction of the antenna that is perpendicular to the azimuth plane.

Base station antennas are directional devices that can concentrate the RF energy that is transmitted in certain directions (or received from those directions). The “gain” of a base station antenna in a given direction is a measure of the ability of the antenna to concentrate the RF energy in that particular direction. The “radiation pattern” (also referred to as an “antenna beam”) of a base station antenna is compilation of the gain of the antenna across all different directions. The antenna beam is typically designed to service a pre-defined coverage area such as the cell or a sector. For example, in a three sector configuration, the antenna beams generated by each base station antenna typically have a Half Power Beam Width (“HPBW”) in the azimuth plane of about 60°-65° so that each antenna beam provides good coverage throughout a 120° sector.

It is also desirable to limit the gain of a base station antenna outside of its coverage area, as the RF energy emitted outside the coverage area may appear as interference in neighboring cells or sectors. Thus, it is typically desirable that the gain of an antenna beam drop off rapidly at azimuth angles greater than about 60°-65° from the boresight pointing direction of a base station antenna in order to reduce the amount of interfering RF energy that a base station antenna emits into adjacent sectors of the base station. Wireless operators also try to control how far the radiation patterns generated by a base station antenna propagate in order to reduce or minimize interference with nearby base stations. The primary way in which this is accomplished is by controlling the elevation angle at which the peak gain of the antenna beam occurs (which is referred to herein as the elevation angle of the antenna beam). For example, a base station antenna having an antenna beam with an elevation angle of 0° will radiate much of the RF energy for an extended distance, whereas most of the RF energy radiated from a base station antenna having an antenna beam with an elevation angle of −10° will be contained within a much smaller region. Thus, by reducing the elevation angle of the antenna beam, the size of the 120° sector may be reduced.

Base station antennas are typically mounted for use so that the longitudinal axis of the antenna is oriented along a vertical axis (i.e., along an axis that is perpendicular the plane defined by the horizon). With early base station antennas, the only way to change the elevation angle (also referred to as the “tilt” angle) of the antenna beam was to physically change the tilt angle at which the base station antenna was mounted. Most modern base station antennas, however, have an ability to electronically alter the pointing direction of the antenna beam in the elevation plane. Base station antennas having such capabilities are referred to as remote electronic tilt (“RET”) antennas. Moreover, while mechanically downtilting a base station antenna directs the forwardly-directed radiation more toward the ground and the backwardly-directed radiation toward higher elevation angles (i.e., more towards the sky), electronically downtilting acts to downtilt the antenna beam in all directions. The difference between mechanical and electronic downtilts is schematically illustrated in FIG. 1A. As shown on the left side of FIG. 1A, an antenna beam 12 that is generated by a base station antenna 10 includes forwardly-directed radiation 14 and backwardly-directed radiation 16. The longitudinal axis of the base station antenna 10 is tilted with respect to a vertical axis V that extends perpendicular to the horizon in order to mechanically downtilt the antenna 10. The mechanical downtilt applied to the antenna 10 tilts the forwardly-directed radiation 14 of the antenna beam 12 downwardly with respect to the horizon (the horizon is the plane defined by the circle 18), uptilts the backwardly-directed radiation 16 of the antenna beam 12 to point above the horizon 18, and does not apply any tilt at 90° and −90° from the mechanical boresight pointing direction of the antenna 10. In contrast, the right side of FIG. 1A illustrates an electronically downtilted antenna beam 22 generated by an antenna 20 that includes forwardly-directed radiation 24 and backwardly-directed radiation 26. As shown, the electronic downtilt tilts the antenna beam 22 downwardly with respect to the horizon 28 in all directions. The contour 29 shown in the sphere on the right side of FIG. 1A represents the contour of peak emission.

It has been rumored that at least one wireless operator has previously mounted base station antennas to have a small mechanical uptilt, although the reason for the uptilt was not known. FIG. 1B graphically illustrates a base station antenna 30 that is uptilted by an angle α with respect to a vertical axis V in order to mechanically uptilt the antenna beam 32 generated by the base station antenna 30.

Base station antennas typically include one or more linear arrays and/or two-dimensional arrays of radiating elements such as patch, dipole or crossed dipole radiating elements. While the discussion above assumes that each base station antenna includes a single array, most modern base station antennas now include two, three or more arrays of radiating elements, each of which may effectively function as a separate antenna. In order to electronically change the downtilt angle of these arrays, a phase taper may be applied to the sub-components of the RF signal that are transmitted by the individual radiating elements of the array, as is well understood by those of skill in the art. Such a phase taper may be applied, for example, by adjusting the settings on an adjustable phase shifter that is positioned along the RF transmission path between a radio and the individual radiating elements included in the array. A wide variety of suitable phase shifters are known in the art such as, for example, the phase shifters disclosed in U.S. Pat. No. 7,907,096 to Timofeev, the disclosure of which is incorporated herein by reference in its entirety.

One performance parameter for a base station antenna is its “sector power ratio.” The sector power ratio is the ratio of the RF power radiated outside the sector (i.e., at azimuth angles that are outside of the sector) to the RF power radiated within the sector (i.e., at azimuth angles that are within the sector). A very high-performing base station antenna will typically have a sector power ratio in the 3-4% range, although many base station antennas have higher (i.e., worse) sector power ratios (e.g., sector power ratios of 6-8%). Sector power ratio is an important performance parameter for an antenna, as power radiated outside of the sector is not only lost power that does not improve the performance of the antenna, this lost power may also represent interference that must be overcome in adjacent sectors. Accordingly, techniques for improving the sector power ratio of base station antennas are desired.

### SUMMARY

Pursuant to embodiments of the present invention, base station antennas are provided that include a reflector, a first RF port, an array of radiating elements, where each radiating element is mounted to extend forwardly from the reflector and mechanically uptilted with respect to the reflector, and a feed network coupled between the first RF port and the array of radiating elements. The feed network includes a plurality of delay elements that are configured to impart a fixed electronic downtilt to a radiation pattern generated by the array of radiating elements in response to an RF signal input at the first RF port.

In some embodiment, the array of radiating elements is configured so that an elevation angle of a mechanical boresight pointing direction of the array may be greater than 1° when the base station antenna is mounted for use. In other embodiments, the elevation angle of the mechanical boresight pointing direction of the array may be greater than 4° when the base station antenna is mounted for use.

In some embodiments, each radiating element may have a mechanical uptilt with respect to the reflector of at least 4 degrees. In other embodiments, the mechanical uptilt may be at least 8 degrees. In some embodiments, each radiating element may have a mechanical uptilt such that is sufficient to reduce the gain of the antenna beam generated by the base station antenna by at least 10 dB at the horizon.

In some embodiments, the feed network may further include an adjustable electronic downtilt unit.

In some embodiments, each radiating element may be mechanically uptilted an amount so that in the absence of any electronic downtilt, a maximum gain of the radiation pattern at the horizon is at least 7 dB less than a maximum gain of the radiation pattern generated by the array of radiating elements.

In some embodiments, each radiating element may include a director. The directors may be positioned to be parallel to the reflector.

In some embodiments, the absolute value of an angle of the fixed electronic downtilt may be within two degrees of an absolute value of the elevation angle of a mechanical boresight pointing direction of the array of radiating elements. In other embodiments, the absolute value of the angle of the fixed electronic downtilt may exceed an absolute value of the elevation angle of a mechanical boresight pointing direction of the array of radiating elements.

In some embodiments, the array of radiating elements may be a staggered vertical array of radiating elements.

In some embodiments, the delay elements may be implemented as transmission line segments having pre-selected lengths that are selected to impart a phase taper to the sub-components of RF signals provided to respective sub-arrays of the radiating elements.

Pursuant to further embodiments of the present invention, base station antennas are provided that include a reflector, a first RF port, an array of radiating elements, each of which is mounted to extend forwardly from the reflector, and a feed network coupled between the first RF port and the array of radiating elements. Each radiating element is mechanically uptilted so that an elevation angle of a mechanical boresight pointing direction of the array of radiating elements has a first value that is greater than 0° when the base station antenna is mounted for use. Additionally, the feed network is configured to impart a fixed electronic downtilt to a radiation pattern generated by the array of radiating elements in response to an RF signal input at the first RF port, wherein the fixed electronic downtilt lowers the elevation angle of the mechanical boresight pointing direction of the radiation pattern by a second value that is at least half the first value.

In some embodiments, the first value may differ from the second value by no more than 2°. In some embodiments, the first value may be substantially equal to the second value.

In some embodiments, feed stalks of each radiating element may be mounted to extend perpendicular to the reflector, and a portion of the reflector that is immediately behind a first of the radiating elements may be mounted at an angle of at least 3 degrees with respect to a vertical axis of the base station antenna.

In some embodiments, each of the radiating elements may be mechanically uptilted with respect to the reflector. For example, each radiating element may have a mechanical uptilt of at least 4° or of at least 8°. In such embodiments, each radiating element may include a director that is positioned to be parallel to the reflector.

In some embodiments, the array of radiating elements may be a staggered vertical array of radiating elements. and/or the feed network may further include an adjustable electronic downtilt unit.

### BRIEF DESCRIPTION OF THE DRAWINGS

FIG. 1A is a schematic diagram illustrating the different effects that mechanical and electronic downtilts have on the radiation pattern generated by an array of radiating elements.

FIG. 1B illustrates a base station antenna having slightly uptilted radiating elements.

FIG. 2 is a schematic view of a conventional base station antenna having an array of radiating elements that has neither mechanical or electronic tilt. FIG. 2 also includes a schematic “cut” through the antenna beam generated by the array that is taken along a contour (here a plane) where the antenna beam has peak gain.

FIGS. 3A and 3B are a simulated azimuth pattern (taken at an elevation angle of 0°) and a simulated elevation pattern (taken at an azimuth angle of 0°), respectively, of the antenna beam generated by the array of the conventional base station antenna of FIG. 2.

FIG. 4 is a schematic view of a base station antenna having an array of radiating elements that are mechanically uptilted without any electronic tilt. FIG. 4 also includes a schematic cut through the antenna beam generated by the array that is taken along a contour (here a plane) where the antenna beam has peak gain.

FIGS. 5A and 5B are a simulated azimuth pattern (taken at an elevation angle of 0°) and a simulated elevation pattern (taken at an azimuth angle of 0°), respectively, of the antenna beam generated by the array of the base station antenna of FIG. 4, with the simulated azimuth and elevation patterns of FIGS. 3A and 3B added for comparative purposes.

FIG. 6 is a schematic view of a base station antenna having an array of radiating elements that are mechanically uptilted and electronically downtilted. FIG. 6 also includes a schematic cut through the antenna beam generated by the array that is taken along a contour where the antenna beam has peak gain.

FIGS. 7A and 7B are a simulated azimuth pattern (taken at an elevation angle of 0°) and a simulated elevation pattern (taken at an azimuth angle of 0°), respectively, of the antenna beam generated by the array of the base station antenna of FIG. 6, with the simulated azimuth and elevation patterns of FIGS. 3A-3B and 5A-5B included for comparative purposes.

FIGS. 8A and 8B are measured azimuth and elevation patterns, respectively, of the antenna beam generated by the array of the base station antenna of FIG. 2 shown for a variety of different frequencies across an operating frequency band of the array.

FIGS. 9A and 9B are measured azimuth and elevation patterns, respectively, of the antenna beam generated by the array of the base station antenna of FIG. 6 shown for a variety of different frequencies across an operating frequency band of the array.

FIGS. 10A and 10B are measured azimuth and elevation patterns that correspond to the simulated patterns of FIGS. 7A and 7B.

FIG. 11 is a graph illustrating the measured azimuth beamwidth for an array of radiating elements that has neither mechanical uptilt or electronic downtilt and for an array of radiating elements that has both a mechanical uptilt and an offsetting electronic downtilt.

FIG. 12 is a graph illustrating the sector power ratio for an array of radiating elements that has neither mechanical uptilt or electronic downtilt and for an array of radiating elements that has both a mechanical uptilt and an offsetting electronic downtilt.

FIG. 13A is a perspective view of a base station antenna according to embodiments of the present invention.

FIG. 13B is a schematic plan view of the base station antenna of FIG. 13A that illustrates the three linear arrays of radiating elements included therein.

FIG. 13C is a schematic side view illustrating a low-band radiating element having a mechanical uptilt that may be used to implement the low-band radiating elements in the base station antenna of FIG. 13A.

FIG. 13D is a schematic side view illustrating a high-band radiating element having a mechanical uptilt that may be used to implement the high-band radiating elements in the base station antenna of FIG. 13A.

FIG. 14 is a schematic block diagram illustrating the electrical connections between various of the components of the base station antenna of FIG. 13A.

FIG. 15 is a front perspective view of a pair of electromechanical phase shifters that may be included in the base station antenna of FIG. 13A.

FIG. 16 is a schematic view of a staggered linear array that may be included in the base station antennas according to embodiments of the invention.

FIG. 17 is a schematic block diagram of a base station antenna according to further embodiments of the present invention that has a linear array of mechanically downtilted radiating elements and a feed network that applies a fixed electronic uptilt.

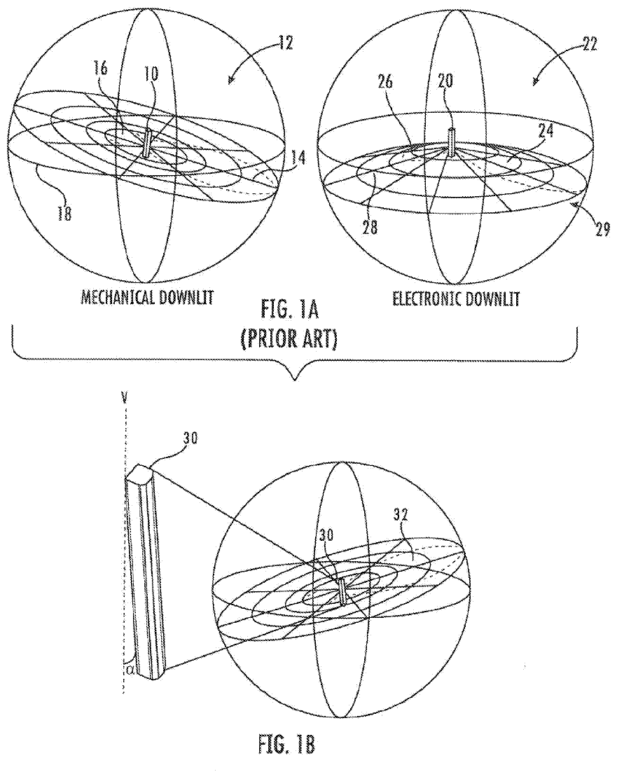

### DETAILED DESCRIPTION

Pursuant to embodiments of the present invention, base station antennas are provided that include arrays of radiating elements that are mechanically uptilted and that are also electronically downtilted. It has been discovered that the combination of a mechanical uptilt with an electronic downtilt may result in antenna beams that have narrower azimuth beamwidths, improved front-to-back ratio and/or reduced magnitude sidelobes at upper elevation angles. In light of these improvements, base station antennas that include arrays of radiating elements that are mechanically uptilted and electronically downtilted may exhibit significantly improved sector power ratios as compared to conventional base station antennas. In some embodiments, the mechanical uptilt may be at least four degrees. In other embodiments, the mechanical uptilt may be at least six degrees, or at least eight degrees.

In some embodiments, the feed networks for the arrays of radiating elements may include a plurality of delay elements that provide a fixed electronic downtilt to the antenna beam generated by the array. For example, the RF transmission paths to the radiating elements, or to sub-arrays of radiating elements, may be configured to have different lengths. As a result, the sub-components of an RF signal that are fed to each sub-array of at least one radiating element will be phased differently, and these phase differences may be configured so that a pre-selected amount of electronic downtilt will be applied to the RF signal. The amount of downtilt applied by the delay elements may not be adjustable by a cellular operator, but instead may be a fixed, unchangeable amount, or an amount that can only be adjusted by removing a housing of the antenna. The base station antennas according to embodiments of the present invention, however, may further include one or more adjustable electronic downtilt units such as electromechanical phase shifters that cellular operators may use to adjust the amount of electronic downtilt in order to, for example, change the size of a 120 degree sector to accommodate installation of a new base station that serves the outer portion of the original sector.

The provision of both a fixed electronic downtilt unit and an adjustable electronic downtilt unit may have certain advantages. Typically, the physical size of an adjustable electronic downtilt unit increases with increasing range of downtilt. For example, an adjustable downtilt unit that may apply up to twelve degrees of electronic downtilt will be larger than an adjustable downtilt unit that may apply up to eight degrees of electronic downtilt. In typical applications, cellular operators often require that a base station antenna be capable of electronically downtilting an antenna beam from about 1-10 degrees below the horizon. In some embodiments, the fixed electronic downtilt may be about the same as the mechanical uptilt. For example, if the radiating elements are mechanically uptilted by 8°, the fixed electronic downtilt may be about 8° or more of downtilt, which offsets the mechanical uptilt. The adjustable electronic downtilt unit (e.g., a phase shifter) may then be configured to apply between 1-10 degrees of electronic downtilt to meet cellular operator requirements. Thus, even though mechanical uptilt is applied, the size of the adjustable electronic downtilt unit need not be increased.

Herein, the “mechanical boresight pointing direction” of a radiating element, an array of radiating elements or an antenna including an array of radiating elements is the direction corresponding to the azimuth and elevation angle at which the peak radiation of the radiating element/array/antenna is directed when no electronic steering (e.g., electronic downtilt) is applied to the RF signal. A radiating element is “mechanically uptilted” if the radiating element is mounted so that the peak radiation emitted by the radiating element is at an elevation angle of greater than 1°. The mechanical uptilt may be achieved, for example, by (1) mounting the radiating elements at an angle on the reflector of the base station antenna so that an elevation angle of the mechanical boresight pointing direction of each radiating element exceeds 1° when a longitudinal axis of the base station antenna is mounted along a vertical axis or (2) by providing a base station antenna having radiating elements that are mounted perpendicular to a vertically-extending reflector and then mounting the base station antenna so that a longitudinal axis thereof is angled from the vertical axis. Herein, a “fixed electronic downtilt” refers to an electronic downtilt that is pre-configured into the feed network of an array that cannot be adjusted by an end user.

Embodiments of the present invention will now be discussed in greater detail with reference to the drawings.

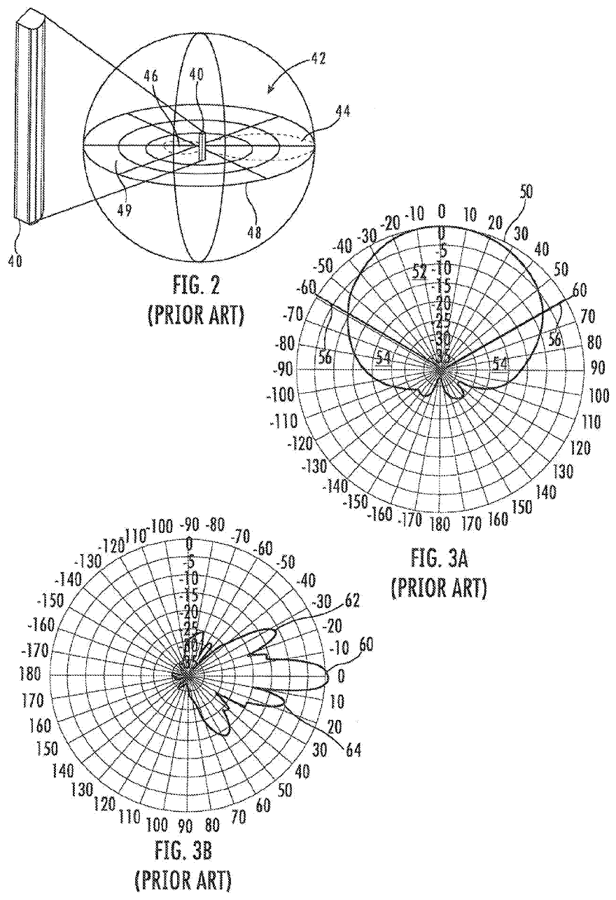

FIG. 2 is a schematic view of a conventional base station antenna 40 having an array of radiating elements (not shown) that has neither mechanical or electronic tilt. FIG. 2 also includes a schematic “cut” through the antenna beam 42 generated by the array that is taken along a contour (here a plane) where the antenna beam 42 has peak gain. As shown in FIG. 2, the antenna beam 42 generated by the base station antenna 40 emits both forwardly-directed radiation 44 and backwardly-directed radiation 46. In FIG. 2, the horizontal disk 49 represents the contour of peak emission. As can be seen, this contour 49 is a plane that is parallel to the horizon 48.

FIGS. 3A and 3B are a simulated azimuth pattern (taken at an elevation angle of 0°) and a simulated elevation pattern (taken at an azimuth angle of 0°), respectively, of the antenna beam 42 generated by the array of the conventional base station antenna 40 of FIG. 2 that has neither mechanical or electronic tilt (i.e., each radiating element emits maximum power at an elevation angle of 0° and no phase taper is applied to the sub-components of the RF signals fed to each radiating element). FIGS. 3A and 3B together show the “shape” of the antenna beam 42 that is generated by the array in terms of the normalized power emitted by the array as a function of direction.

Referring first to FIG. 3A, the curve 50 represents the normalized gain of the antenna beam in the azimuth plane at an elevation angle of 0°. The lines labelled 56 shows the boundaries of the sector covered by the base station antenna 40, with the sector corresponding to azimuth angles of about −60° to 60°. The portion 52 of the region defined by curve 50 and the lines 56 represents the RF energy that is radiated by antenna 40 within the sector, while the portion 54 of the region defined by curve 50 and the lines 56 represents the RF energy that is radiated by antenna 40 outside of the sector. The azimuth half power beamwidth of the antenna beam (i.e., the range of azimuth angles in FIG. 3A that have a gain within 3 dB of the peak gain) is about 71°. It can be seen from FIG. 3A that a substantial amount of radiation is emitted at azimuth angles outside the sector.

Referring to FIG. 3B, curve 60 represents the normalized gain of antenna beam 42 in the elevation plane at an azimuth angle of 0°. As can be seen from FIG. 3B, peak emission for the forwardly-directed radiation 44 is at an elevation angle of about 0°. Both upper sidelobes 62 and lower sidelobes 64 appear in the elevation pattern. The largest upper sidelobe 62 in the elevation pattern has a peak value that is about 16 dB below the peak gain value.

FIG. 4 is a schematic view of a base station antenna 70 having an array of radiating elements (not shown) that are mechanically uptilted by 7.4° without any electronic tilt. FIG. 4 also includes a schematic cut through the antenna beam 72 generated by the array that is taken along a contour (here a plane) where the antenna beam 72 has peak gain. As shown in FIG. 4, the base station antenna 70 generates an antenna beam 72 that has forwardly-directed radiation 74 and backwardly-directed radiation 76. In FIG. 4, the horizontal disk 79 represents the contour of peak emission. As can be seen, this contour 79 is a plane that is tilted upwardly in the forward direction by an angle of 7.4° with respect to the plane defined by the horizon 78. As schematically shown in FIG. 4, the peak emission in the forward direction is tilted upwardly at an angle of 7.4° with respect to the plane defined by the horizon 78, and the peak emission in the rearward direction is tilted downwardly at an angle of 7.4° with respect to the plane defined by the horizon 78. It should also be noted that the radiation pattern does not have any tilt at azimuth angles of 90° and −90°.

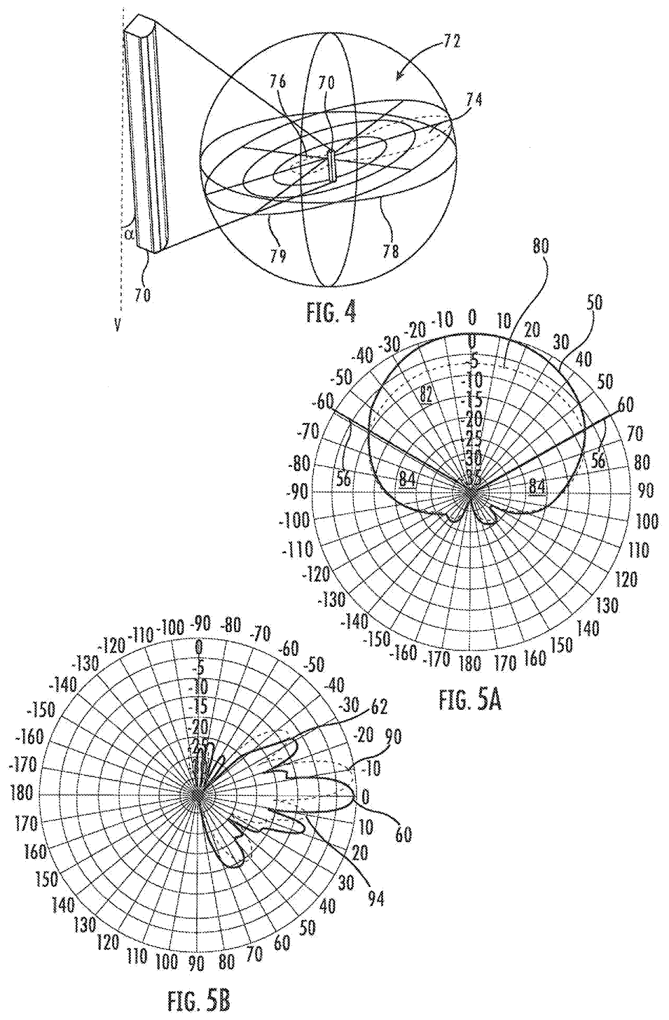

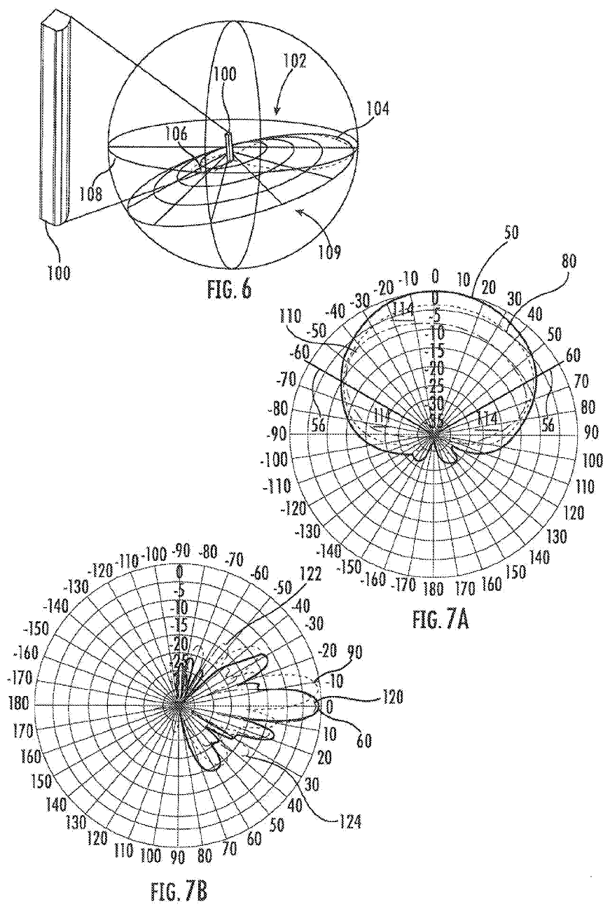

FIGS. 5A and 5B are a simulated azimuth pattern (taken at an elevation angle of 0°) and a simulated elevation pattern (taken at an azimuth angle of 0°), respectively, of the antenna beam 72 generated by the array of the base station antenna 70 of FIG. 4, with the simulated azimuth and elevation patterns 50, 60 of FIGS. 3A and 3B added for comparative purposes. FIGS. 5A and 5B together show the “shape” of the antenna beam 72 that is generated by the array in terms of the normalized power emitted by the array as a function of direction. For purposes of the simulation, it was assumed that the entire antenna 70 was mechanically tilted by 7.4° to implement the mechanical uptilt.

Referring first to FIG. 5A, the curve 80 represents the normalized gain of the antenna beam 72 in the azimuth plane at an elevation angle of 0°. The portion 82 of the region defined by curve 80 and the lines 56 represents the RF energy that is radiated by antenna 70 within the sector, and the portion 84 of the region defined by curve 80 and the lines 56 represents the RF energy that is radiated by antenna 70 outside of the sector. As can be seen in FIG. 5A, the peak gain of the antenna beam 72 in the forward direction is reduced by nearly 8 dB from the gain of the antenna beam 42 generated by the base station antenna 40 of FIG. 2, and a similar reduction is seen in the gain of the backwardly-directed radiation. These reductions in gain occur because the peak emission of antenna beam 72 is above the horizon (and hence above the azimuth cut shown in FIG. 5A) since the antenna beam 72 has a 7.4° mechanical uptilt. The azimuth half power beamwidth of the antenna beam (i.e., the range of azimuth angles in FIG. 5A that have a gain within 3 dB of the peak gain) increases dramatically to about 128°. It can be seen from FIG. 5A that a substantial amount of radiation is emitted at azimuth angles outside the sector (i.e., at azimuth angles of 60° to −60°).

Referring to FIG. 5B, curve 90 represents the normalized gain of antenna beam 72 in the elevation plane at an azimuth angle of 0°. As can be seen from FIG. 5B, peak emission for the forwardly-directed radiation 44 is at an elevation angle of about 7.4° due to the mechanical uptilt to antenna 70. Upper sidelobes 92 and lower sidelobes 94 again appear in the elevation pattern. The elevation cut of FIG. 5B shows that the two antenna beams 42, 72 have basically the same shape, with the only difference being the pointing direction of the antenna beams 42, 72. The skilled artisan would readily recognize that the mechanically up-tilted antenna beam of FIGS. 5A-5B would be unsuitable for essentially all cellular applications, as a large percentage of the radiated energy is being radiated upwardly and hence will not be received by ground-based users.

FIG. 6 is a schematic view of a base station antenna 100 according to embodiments of the present invention that has an array of radiating elements (not shown) that are both internally mechanically uptilted and electronically downtilted. FIG. 6 also includes a schematic cut through the antenna beam 102 generated by the array that is taken along a contour where the antenna beam 102 has peak gain. The array of radiating elements included in base station antenna 100 has mechanical up-tilt of 7.4° and an electronic down-tilt of 8°.

As shown in FIG. 6, the antenna beam 102 has forwardly-directed radiation 104 and backwardly-directed radiation 106. The contour of peak emission 109 is heavily tilted downwardly in the rearward direction, and at an elevation angle of about 0° at the center of the forward direction. This shows that the electronic downtilt compensates for the mechanical uptilt in the center of the forward direction, while the electronic downtilt is additive to the mechanical downtilt in the rearward direction, bringing the peak rearwardly-directed radiation well below the horizon 108. Notably, unlike the case shown in FIG. 4, the antenna beam 102 is tilted downwardly at azimuth angles of both 90° and −90°.

FIGS. 7A and 7B are a simulated azimuth pattern 110 (taken at an elevation angle of 0°) and a simulated elevation pattern 120 (taken at an azimuth angle of 0°), respectively, of the antenna beam 102 generated by the array of the base station antenna 100 of FIG. 6, with the simulated azimuth patterns 50, 80 of FIGS. 3A and 5A and the simulated elevation patterns 60. 90 of FIGS. 3B and 5B included for comparative purposes.

Referring first to FIG. 7A, the curve 110 represents the normalized gain of the antenna beam 102 in the azimuth plane at an elevation angle of 0°. The portion 112 of the region defined by curve 110 and the lines 56 represents the RF energy that is radiated by antenna 100 within the sector, and the portion 114 of the region defined by curve 110 and the lines 56 represents the RF energy that is radiated by antenna 100 outside of the sector. As can be seen from FIG. 7A, by adding the electronic downtilt, the peak gain of the antenna 100 may be brought back to the horizon 108, and hence the peak gain of antenna beam 102 at the horizon 108 is equal to the peak gain of antenna beam 42. Notably, however, the gain of antenna beam 102 decreases or “rolls off” faster at azimuth angles greater than about 30° from the boresight azimuth pointing direction, which results in significantly less radiation being emitted outside the 120° sector as compared to the antenna beam 42 of the conventional base station antenna 40. Because of this faster roll-off, the azimuth half power beamwidth of the antenna beam 102 is reduced to under 69°, and it can also be seen from FIG. 7A that the amount of radiation that is emitted at azimuth angles outside the sector is substantially reduced as compared to the antenna beams 42, 72. The simulated results of FIG. 7A also show that there is much less backwardly-directed radiation at the horizon as compared to the antenna beam 42, which is expected since both the mechanical downtilt and the electronic downtilt reduce emission levels at the horizon.

Referring to FIG. 7B, curve 120 represents the normalized gain of antenna beam 102 in the elevation plane at an azimuth angle of 0°. As can be seen from FIG. 7B, the electronic downtilt brings the peak emission for the forwardly-directed radiation 104 back to the horizon 108. Upper sidelobes 122 and lower sidelobes 124 again appear in the elevation pattern, but it can be seen that the magnitude of the largest upper sidelobe 122 is reduced significantly as compared to the largest upper sidelobes 62, 92 of antenna beams 42, 72, respectively. A smaller amount of reduction is also seen in the largest lower sidelobe 124 as compared to lower sidelobes 64, 94. Both changes are advantageous in terms of maximizing the amount of RF power provided to desired locations within the sector.

Thus, as can be seen from FIGS. 7A and 7B, the base station antenna 100 according to embodiments of the present invention that has arrays of radiating elements that are mechanically uptilted and that are also electronically downtilted has a narrower azimuth beamwidth, improved front-to-back ratio and reduced magnitude upper sidelobes as compared to the conventional base station antenna 40. These changes in the radiation pattern may result in a significantly improved sector power ratio.

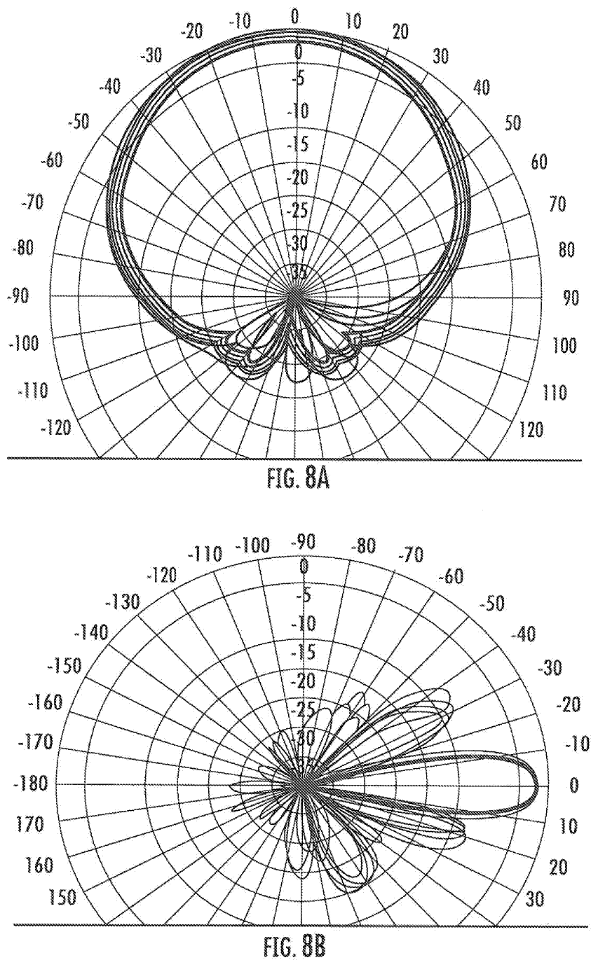

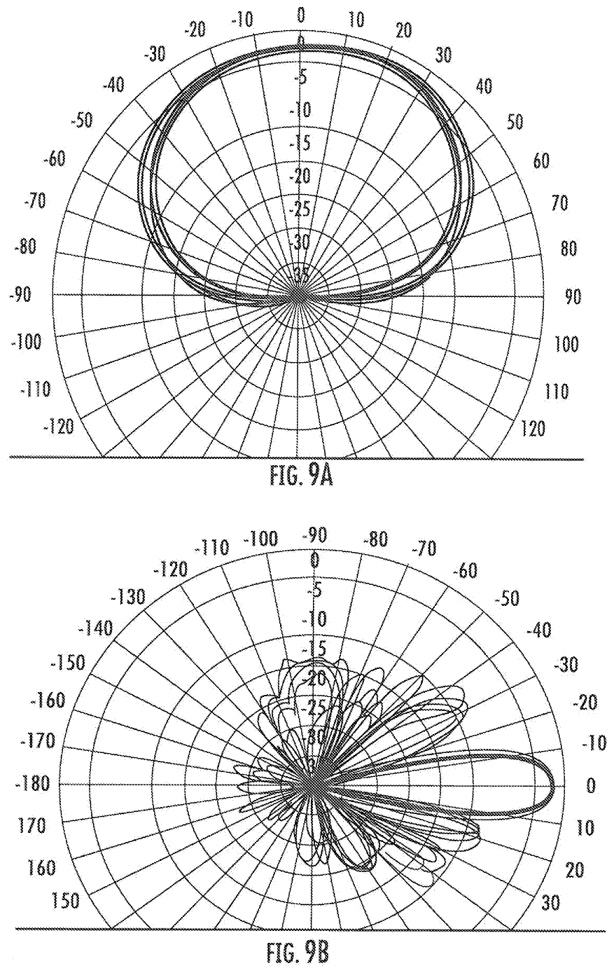

FIGS. 8A and 8B are measured azimuth and elevation patterns, respectively, of the antenna beam 42 generated by the array of the base station antenna 40 of FIG. 2 shown for a variety of different frequencies across an 698-960 MHz operating frequency band of the array. FIGS. 9A and 9B are measured azimuth and elevation patterns, respectively, of the antenna beam generated by the array of the base station antenna of FIG. 6 shown for a variety of different frequencies across the same 698-960 MHz operating frequency band. The goal for many applications is to minimize the variation in these patterns as a function of frequency, particularly with respect to radiation that is emitted within the sector. As can be seen by comparing FIGS. 8A and 9A, the azimuth pattern for the base station antenna 100 according to embodiments of the present invention shows less variation as a function of frequency than does the azimuth pattern for the conventional base station antenna 40 of FIG. 2. Moreover, the 3 dB azimuth beamwidth for the base station antenna 100 according to embodiments of the present invention is, on average across the frequencies simulated, about 3° less than the average 3 dB azimuth beamwidth for the conventional base station antenna 40 of FIG. 2.

The elevation patterns as a function of frequency are shown in FIG. 9B for the base station antenna 100 according to embodiments of the present invention appear to have somewhat more variation than the corresponding elevation patterns as a function of frequency for the conventional base station antenna 40 of FIG. 2 that are shown in FIG. 8B. However, the elevation patterns are comparable for the main lobes, and the variation in the sidelobes of the elevation patterns is less of an issue. Moreover, the peak levels of the elevation sidelobes generated by the base station antenna 100 according to embodiments of the present invention are less than the peak levels of the elevation sidelobes generated by the conventional base station antenna 40, and the difference in sidelobe levels is quite significant with respect to the upper sidelobes (i.e., a difference of about 5 dB). This reduction in the upper elevation sidelobes is highly desirable as RF energy emitted at these higher elevation angles is generally wasted energy, and hence reducing the magnitude of these upper sidelobes is beneficial.

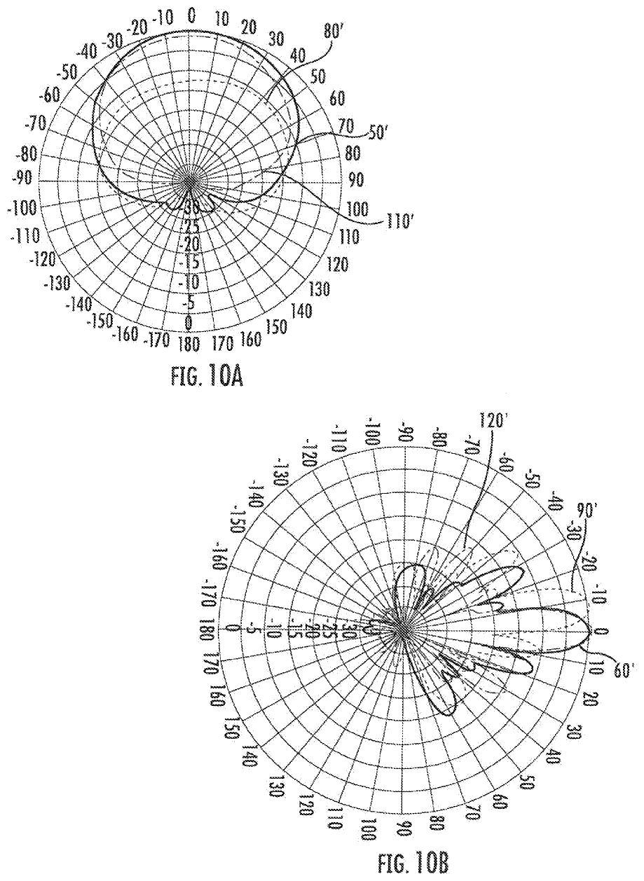

Radiation patterns were also measured for an actual antenna under the three different scenarios described above, namely radiation patterns were generated where the antenna had (1) no mechanical tilt and no electronic tilt (curves 50′, 60′), (2) a 7.4° mechanical uptilt and no electronic tilt (curves 80′, 90′) and (3) a 7.4° mechanical uptilt and an 8° electronic downtilt (curves 110′, 120′). FIGS. 10A and 10B show the azimuth and elevation patterns as measured during these tests. As can readily be seen, the measured pattern data very closely tracks the simulated pattern data, and verifies that the above-discussed advantages in terms of faster roll-off of the azimuth pattern outside the sector, improved front-to-back ratio performance, lower upper elevation sidelobes and improved power sector ratio performance are realized by the base station antennas according to embodiments of the present invention.

FIG. 11 is a graph illustrating the measured azimuth beamwidth (curve 130) for the array of radiating elements of base station antenna 40 of FIG. 2 (i.e., an array of radiating elements that has neither mechanical uptilt or electronic downtilt) and for an array of radiating elements of the base station antenna 100 according to embodiments of the present invention that has both a mechanical uptilt and an offsetting electronic downtilt (curve 132). As shown in FIG. 11, the base station antenna 100 according to embodiments of the present invention has a narrower azimuth 3 dB beamwidth for all frequencies in the 694-960 MHz frequency band except for a small 20 MHz band centered around 758 MHz. Typically, the smaller azimuth 3 dB beamwidths shown for the base station antenna 100 according to embodiments of the present invention would be preferred as compared to the azimuth 3 dB beamwidths shown for the conventional base station antenna 40 of FIG. 2. The mean azimuth 3 dB beamwidth for the base station antenna 100 according to embodiments of the present invention was 68.1°, whereas the mean azimuth 3 dB beamwidth for the conventional base station antenna was 70.2°, or more than 2° larger. The variation in the azimuth 3 dB beamwidth for the base station antenna 100 according to embodiments of the present invention is somewhat higher than the variation for the conventional base station antenna 40 (about 8.5° versus about 7°), but it is believed that this variation could be reduced using other techniques, as will be discussed herein

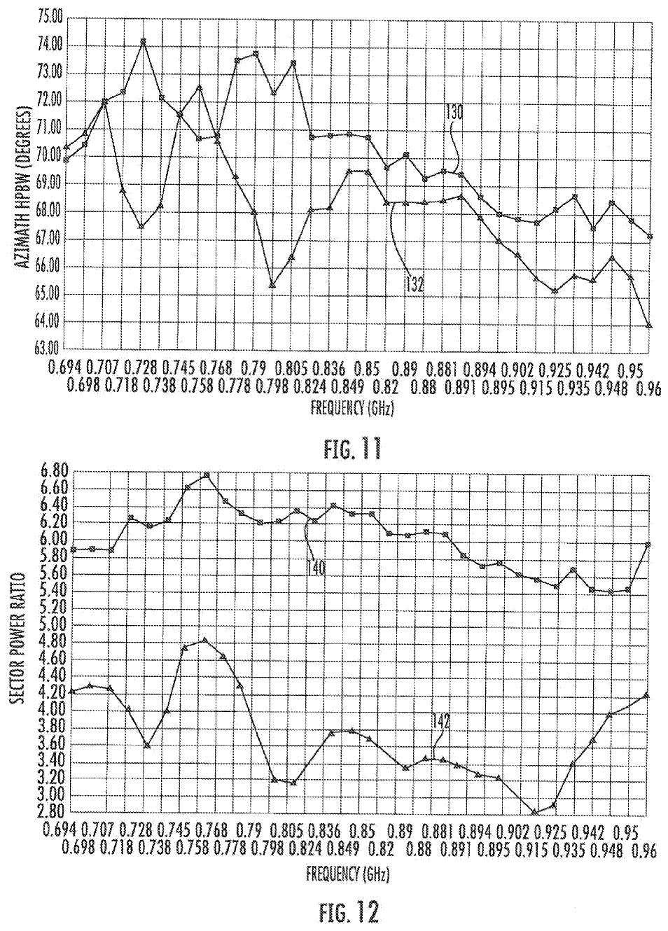

FIG. 12 is a graph illustrating the sector power ratio for an array of radiating elements of the conventional base station antenna 40 that has neither mechanical uptilt or electronic downtilt (curve 140) and for an array of radiating elements of the base station antenna 100 according to embodiments of the present invention that has both a mechanical uptilt and an offsetting electronic downtilt (curve 142). As shown in FIG. 12, the sector power ratio for the conventional base station antenna 40 fluctuated between 5.44 and 6.76, and the mean sector power ratio across the entire bandwidth was just over 6% (6.03%). In contrast, the sector power ratio for the base station antenna 100 according to embodiments of the present invention having both mechanical uptilt and electronic downtilt fluctuated between 2.83 and 4.82, and the mean sector power ratio across the entire bandwidth was well under 4% (3.74%). As discussed above, lower sector power ratios are preferred, with sector power ratios of 7% or less often required by wireless operators, and sector power ratios of 3-4% being considered excellent. Thus, FIG. 12 shows that the base station antennas according to embodiments of the present invention may provide a significant improvement in sector power ratio performance.

In the measured results discussed above, the mechanical uptilt was achieved by tilting a conventional base station antenna that has radiating elements that extend perpendicularly from a reflector with respect to a vertical axis by 7.4°. As a result of the tilt applied to the antenna as a whole, each radiating element also had an 7.4° uptilt. It will be appreciated, however, that an uptilt may alternatively be applied by tilting each individual radiating element upwardly by a desired amount (e.g., 7.4°) and then mounting the base station antenna so that it extends along a vertical axis. When this approach is used, each radiating element may extend from the reflector at an angle of 90° minus the uptilt angle, or individual reflector sections may be provided behind each radiating element that have the same amount of uptilt as the radiating elements so that each radiating element will remain perpendicular to the portion of the reflector directly behind the radiating element. In many applications, cost considerations will require a single flat reflector, and hence the individual radiating elements in such cases will extend from the reflector at an angle between, for example, 80°-89° (assuming mechanical uptilts of 1°-10°).

As described above, pursuant to embodiments of the present invention, base station antennas are provided that are both mechanically uptilted and electronically downtilted. In some embodiments, these base station antennas may include a reflector, an RF port, an array of mechanically uptilted radiating elements, and a feed network coupled between the RF port and the array of radiating elements. The feed network includes a plurality of delay elements that are configured to impart a fixed electronic downtilt to a radiation pattern generated by the array of radiating elements in response to an RF signal input at the RF port.

In some embodiments, an elevation angle of a mechanical boresight pointing direction of the array may be greater than 1° when the base station antenna is mounted for use. In other embodiments, the elevation angle of the mechanical boresight pointing direction of the array may be greater than 4°, greater than 6° or greater than 8°. This may be accomplished, for example, by mechanically uptilting each radiating element with respect to the reflector by at least 1°, at least 4°, at least 6° or at least 8°, respectively.

In some embodiments, the amount of mechanical uptilt may be selected so that the gain of the antenna at the horizon is reduced by a pre-selected amount when no electronic downtilt is applied to the array. For example, each radiating element may be mechanically uptilted an amount so that in the absence of any electronic downtilt, a maximum gain of the radiation pattern at the horizon is at least 7 dB less than a maximum gain of the radiation pattern generated by the array of radiating elements. In other words, each radiating element may have a mechanical uptilt that is sufficient to reduce the gain of the antenna beam generated by the base station antenna by at least 7 dB at the horizon. In other embodiments, the radiating elements may be mechanically uptilted amounts so that the maximum gain of the radiation pattern at the horizon, in the absence of any electronic downtilt, may be at least 3 dB, 5 dB or 9 dB less than maximum gain of the radiation pattern at the horizon.

In some embodiments, the delay elements may be configured to impart a fixed electronic downtilt that is within 2° of an absolute value of the elevation angle of a mechanical boresight pointing direction of the array of radiating elements. In other embodiments, the absolute value of the angle of the fixed electronic downtilt may exceed an absolute value of the elevation angle of a mechanical boresight pointing direction of the array of radiating elements.

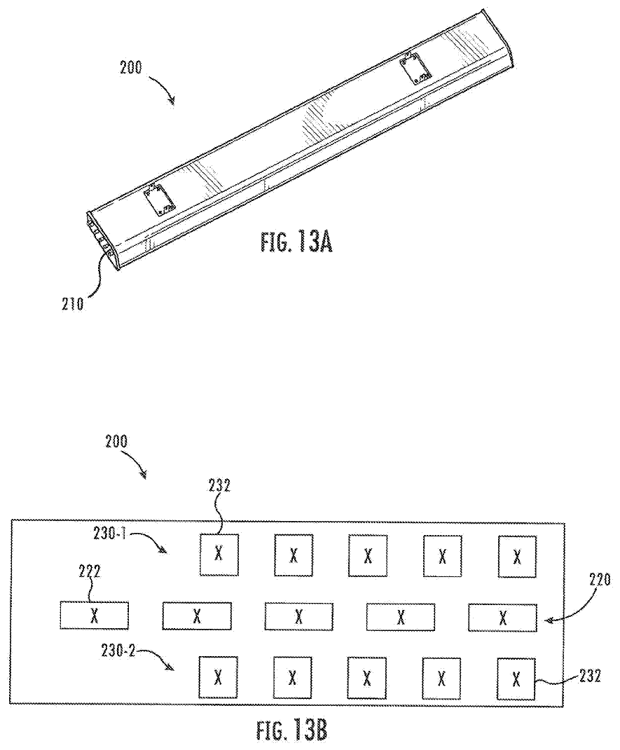

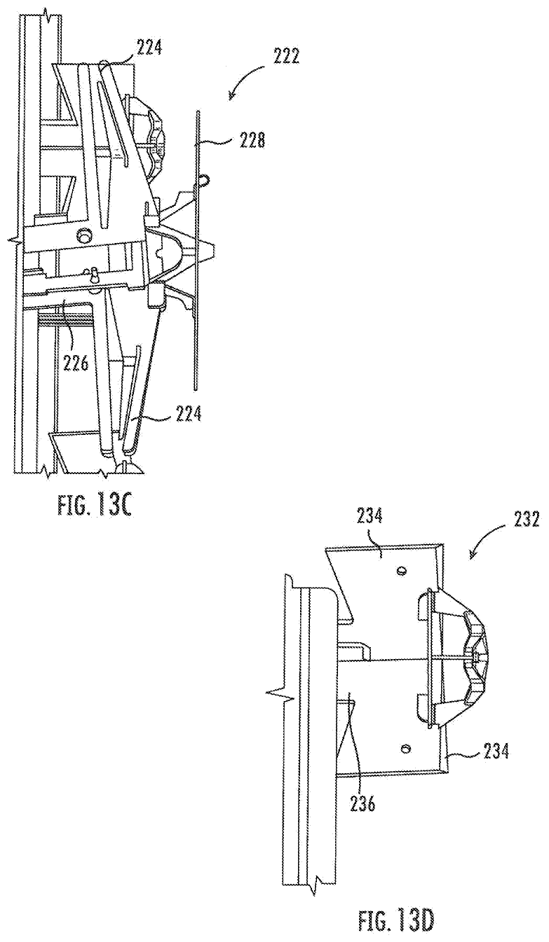

FIGS. 13A-13D illustrate a base station antenna 200 according to embodiments of the present invention. In particular, FIG. 13A is a perspective view of the base station antenna 200, and FIG. 13B is a schematic plan view of the base station antenna 200 that illustrates the three linear arrays 220 and 230-1, 230-2 of radiating elements included therein. FIGS. 13C and 13D are schematic side views, respectively, of a low-band radiating element 222 and a high-band radiating element 232 that each have a mechanical uptilt that may be used to implement the low-band radiating elements and the high-band radiating elements, respectively, in the base station antenna 200.

Referring to FIGS. 13A and 13B, the base station antenna 200 includes a plurality of input/output ports 210 that may be connected to respective radio ports (not shown), a linear array 220 of low-band radiating elements 222, and two linear arrays 230-1, 230-2 of high-band radiating elements 232.

Referring to FIG. 13C, a mechanically uptilted low-band radiating element 222 is illustrated that could be used in the base station antenna 200 of FIG. 13A. The low-band radiating element 222 includes dipole arms 224 and a feed stalk 226. The radiating element 222 may include a total of four center-fed dipole arms 224 that are arranged as two generally collinear pairs of dipole arms 224 that extend at angles of −45° and +45° with respect to the horizon when the antenna 200 is mounted for normal use. The radiating element 222 depicted in FIG. 13C is an individually tilted radiating element, meaning that the feed stalk 226 is not mounted to be perpendicular to the reflector (not shown) that is mounted behind the radiating element. For example, the feed stalk may be titled by an angle α from 90° in order to mechanically uptilt the radiating element by the angle α. In some embodiments, the angle α may be at least 1°, at least 3°, at least 5° or at least 7°. As is further shown in FIG. 13C, the radiating element 222 includes a director 228 is mounted forwardly of the dipole arms 224. Notably, the director 228 may be mounted to be parallel to the plane defined by the reflector.

Referring to FIG. 13D, a mechanically uptilted high-band radiating element 232 is illustrated that could be used in the base station antenna 200 of FIG. 13A. The high-band radiating element 232 includes dipole arms 234 and a feed stalk 236. The radiating element 232 may include a total of four center-fed dipole arms 234 that are arranged as two generally collinear pairs of dipole arms that extend at angles of −45° and +45° with respect to the horizon when the antenna 200 is mounted for normal use. The radiating element 232 depicted in FIG. 13D is an individually tilted radiating element. For example, the feed stalk 236 may be titled by an angle α from 90° in order to mechanically uptilt the radiating element by the angle α.

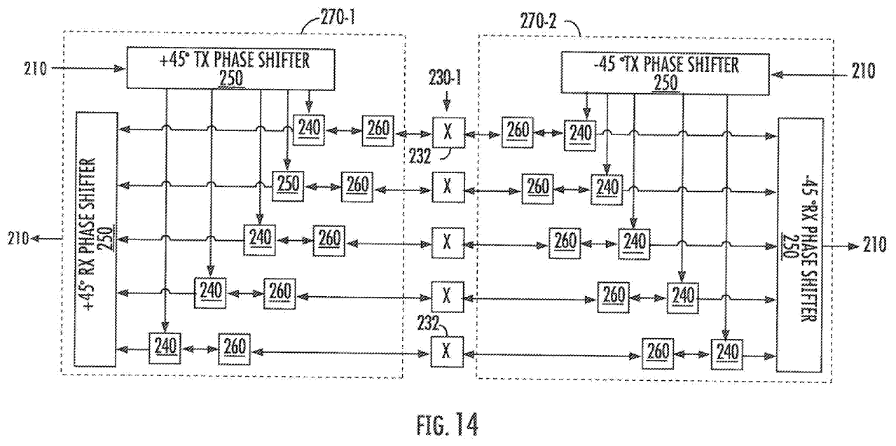

FIG. 14 is a schematic block diagram illustrating the electrical connections between the input/output ports 210 and one of the linear arrays of radiating elements (here linear array 230-1). The other two linear arrays 220, 230-2 may have similar or identical feed networks that connect their input/output ports 210 to the radiating elements 222, 232 thereof. The radiating elements included in base station antenna 200 comprise slant −45°/+45° cross-polarized dipole radiating elements 222, 232, and hence each radiating element 232 in FIG. 14 is shown schematically using an “X” that reflects that the radiating element includes two independent dipole radiators, namely a −45° dipole radiator and a +45° dipole radiator. It will be appreciated, however, that any appropriate radiating element 222, 232 may be used including, for example, single dipole radiating elements or patch radiating elements (including cross-polarized patch radiating elements).

As is further shown in FIG. 14, duplexers 240, adjustable phase shifters 250 and fixed delay elements 260 are interposed on the RF transmission paths that connect the input/output ports 210 to the linear array 230-1. These elements form a pair of feed networks 270-1, 270-2 for the linear array 230-1. A pair of feed networks 270 are provided for linear array 230-1 since the linear array includes cross-polarized radiating elements 232, with the first feed network 270-1 carrying RF signals having the first polarization (e.g., −45°) between the radiating elements 232 and a first pair of input/output ports 210 and the second feed network 270-2 carrying RF signals having the second polarization (e.g., +45°) between the radiating elements 232 and a second pair of input/output ports 210, as shown in FIG. 14.

An input of each transmit (“TX”) phase shifter 250 may be connected to a respective one of the input ports 210. Each input port 210 may be connected to the transmit port of a radio (not shown). Each transmit phase shifter 250 has five outputs that are connected to respective ones of the radiating elements 232 through respective duplexers 240 and fixed delay elements 260. Each transmit phase shifter 250 may divide an RF signal that is input thereto into a plurality of sub-components and may effect a phase taper to the sub-components of the RF signal that are provided to the radiating elements 232 in order to electronically downtilt the antenna beams generated by the linear array 230-1. The transmit phase shifters 250 may be adjustable phase shifters so as to allow the cellular operator to dynamically adjust the amount of electronic downtilt applied in order to, for example, alter the size of the coverage area of linear array 230-1.

The fixed delay elements 260 may likewise be configured to apply an electronic downtilt to the antenna beams generated by the linear array 230-1. The fixed delay elements 260, however, may not be adjustable by the cellular operator but instead may be fixed at the time of manufacture of the antenna 200. In some embodiments, each fixed delay element 260 may simply comprise a transmission line segment such as, for example, a coaxial cable segment or a microstrip transmission line. Each fixed delay element 260 in a feed network 270 may be configured to impart a different amount of phase delay with respect to the other fixed delay elements 260 in the feed network 270 so that a phase taper is applied to the sub-components of the RF signal which effects the electronic downtilt.

The fixed delay elements 260 of feed network 270-1 may be configured to apply a linear phase taper to the −45° dipole radiators of radiating elements 232 of linear array 230-1. As an example, the fixed delay element 260 connected to the first radiating element 232 may impart an additional phase delay of −2X°, the fixed delay element 260 connected to the second radiating element 232 may impart an additional phase delay of −X°, the fixed delay element 260 connected to the third radiating element 232 may impart no additional phase delay, the fixed delay element 260 connected to the fourth radiating element 232 may impart an additional phase delay of X°, and the fixed delay element 260 connected to the fifth radiating element 232 may impart an additional phase delay of 2X°, where the radiating elements 232 are arranged in numerical order. The value of X may be selected to impart a desired amount of fixed electronic downtilt to the antenna beam generated by the −45° dipole radiators of the radiating elements 232 of linear array 230-1.

While each radiating element 232 in antenna 200 is connected to a respective fixed delay unit 260, it will be appreciated that in other embodiments the output of one or more of the fixed delay units 260 may be split into two or more sub-components that are provided to respective radiating elements. For example, each radiating element 232 shown in FIG. 14 could be replaced with a feedboard that includes two or three radiating elements 232 thereon. Each feed board could be connected to a respective one of the fixed delay units 260, and each feed board may include a power divider that splits the power of the RF signal output by its associated fixed delay unit 260 into multiple sub-components that are provided to the respective radiating elements 232 mounted on the feedboard. Thus, it will be appreciated that each fixed delay unit 260 may be coupled to a sub-array of radiating elements 232, where each sub-array includes one or more radiating elements 232.

As is further shown in FIG. 14, the receive portion of each feed network 270 may be configured to operate in the same manner as the transmit portion of the feed network, with the only difference being the direction of RF signal travel is reversed. As such, further description of the receive portion of each feed network 270 will be omitted here.

In some embodiments, the fixed delay elements 260 may have associated delays that are configured to generate a fixed electronic downtilt that is about equal and opposite in value to the amount of mechanical uptilt applied to the radiating elements 232. For example, if each radiating element 232 is mechanically uptilted by about 8°, then the fixed delay elements 260 may be configured to generate an electronic downtilt of about 8°. In this fashion, the fixed delay elements 260 may generate an electronic downtilt that essentially offsets the mechanical uptilt. The adjustable electronic downtilt unit in the form of the transmit and receive phase shifters 250 may be used by the cellular operator to apply additional electronic downtilt (or perhaps uptilt) to the antenna beams generated by the linear array 230-1.

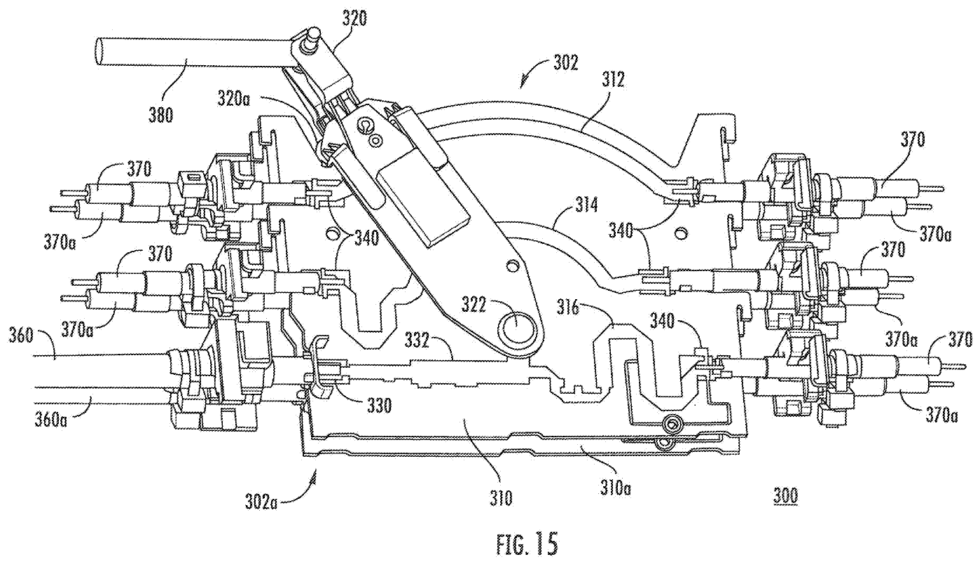

Each adjustable phase shifter 250 shown in FIG. 14 may be implemented, for example, as a rotating wiper phase shifter. The phase shifts imparted by an adjustable phase shifter 250 to each sub-component of an RF signal may be controlled by a mechanical positioning system that physically changes the position of the rotating wiper of each phase shifter 250, as will be explained with reference to FIG. 15.

Referring to FIG. 15, a dual rotating wiper phase shifter assembly 300 is illustrated that may be used to implement, for example, the two transmit phase shifters 250 in FIG. 14. The dual rotating wiper phase shifter assembly 300 includes first and second phase shifters 302, 302a.

As shown in FIG. 15, the dual phase shifter 300 includes first and second main (stationary) printed circuit boards 310, 310a that are arranged back-to-back as well as first and second rotatable wiper printed circuit boards 320, 320a that are rotatably mounted on the respective main printed circuit boards 310, 310a. The position of each rotatable wiper printed circuit boards 320, 320a above its respective main printed circuit board 310, 310a is controlled by the position of a mechanical linkage 380 (partially shown in FIG. 3) that extends between an output member of an actuator (not shown) and the phase shifter assembly 300.

Each main printed circuit board 310, 310a includes generally arcuate transmission line traces 312, 314. The first arcuate transmission line trace 312 is positioned along an outer circumference of each printed circuit board 310, 310a, and the second arcuate transmission line trace 314 has a shorter radius and is positioned concentrically within the outer transmission line trace 312. A third transmission line trace 316 on each main printed circuit board 310, 310a connects an input pad 330 on each main printed circuit board 310, 310a to an output pad 340 that is not subjected to an adjustable phase shift.

The main printed circuit board 310 includes one or more input traces 332 leading from the input pad 330 to the position where a pivot pin 322 is located. RF signals on the input trace 332 are coupled to a transmission line trace (not visible in FIG. 15) on the wiper printed circuit board 320, typically via a capacitive connection. The transmission line trace on the wiper printed circuit board 320 may split into two secondary transmission line traces (not shown). The RF signals are capacitively coupled from the secondary transmission line traces on the wiper printed circuit board 320 to the transmission line traces 312, 314 on the main printed circuit board 310, 310a. Each end of each transmission line trace 312, 314 may be coupled to a respective output pad 340. A coaxial cable 360 may be connected to input pad 230, and a respective coaxial cable 370 may be connected to each output pad 340. As the wiper printed circuit board 320 moves, an electrical path length from the input pad 330 of phase shifter 302 to each radiating element 232 served by the transmission lines 312, 314 changes. For example, as the wiper printed circuit board 320 moves to the left it shortens the electrical length of the path from the input pad 330 to the output pad 340 connected to the left side of transmission line trace 312 (which connects to a first radiating element 232), while the electrical length from the input pad 330 to the output pad 340 connected to the right side of transmission line trace 312 (which connects to a second radiating element 232) increases by a corresponding amount. These changes in path lengths result in phase shifts to the signals received at the output pads 340 connected to transmission line trace 312 relative to, for example, the output pad 340 connected to transmission line trace 316. The second phase shifter 302a may be identical to the first phase shifter 302, and hence description thereof will be omitted.

One potential issue with base station antennas that include both a mechanical uptilt and an electronic downtilt is that the greater the tilt values, the smaller the azimuth beamwidth of the corresponding antenna beam. Thus, for example, if the base station antenna 100 of FIG. 6 is configured to have an 8° mechanical uptilt and an electronic downtilt of 13°, the 3 dB azimuth beamwidth of the antenna may shrink considerably further. As discussed above with reference to FIG. 11, the 3 dB beamwidth of an antenna beam is typically a function of the frequency of the RF signal that generates the antenna beam, with higher frequencies generally corresponding to reduced 3 dB bandwidths. Simulations have shown that if the base station antenna 100 of FIG. 6 is operated with a 10° adjustable downtilt, at the highest frequencies in the operating frequency band (here 862 MHz) the 3 dB azimuth beamwidth may be reduced to about 54°. This 3 dB beamwidth may be too small for some applications, but may actually be preferred for other applications, such as many urban applications.

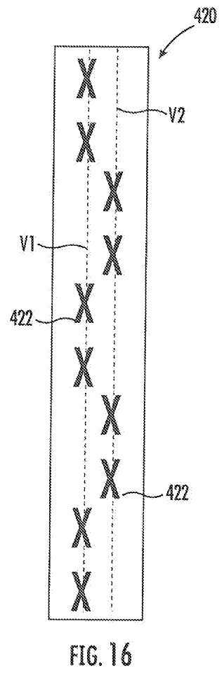

Pursuant to further embodiments of the present invention, any of the above-described base station antennas may include linear arrays that are designed to provide improved beamwidth stability as a function of frequency. For example, U.S. Provisional Patent Application Ser. No. 62/722,238, filed Aug. 24, 2018, discloses using so-called “staggered” vertical arrays of radiating elements to provide improved azimuth beamwidth stability across an operating frequency band for a radiating element. Herein, a “staggered” vertical array refers to an array of radiating elements in which the radiating elements are spaced apart from one another in the vertical direction with at least some of the radiating elements staggered in the horizontal direction with respect to other of the radiating elements by a relatively small distance. Thus, a staggered vertical array generally extends vertically, but the radiating elements are aligned along two or more vertical axes instead of all being aligned along the same vertical axis, as is the case in a conventional vertically-oriented linear array of radiating elements. Generally speaking, the stagger may tend to offset the decrease in azimuth beamwidth that occurs with increasing frequency, and hence may increase the minimum 3 dB azimuth beamwidth for an array. FIG. 16 schematically illustrates such a staggered vertical array of radiating elements. As shown in FIG. 16, the staggered vertical array 420 includes a plurality of radiating elements 422 that extend forwardly from a reflector 402 of a base station antenna. As shown in FIG. 16, the radiating elements 422 are vertically spaced apart from one another and are arranged along two spaced-apart vertical axes V1 and V2.

While the above-discussed embodiments of the present invention are directed to base station antennas that combine mechanically uptilted radiating elements with an electronic downtilt, embodiments of the present invention are not limited thereto. In particular, pursuant to further embodiments of the present invention, base station antennas are provided that combine mechanically downtilted radiating elements with an electronic uptilt.

As discussed above, when mechanical uptilt is combined with electronic downtilt, the radiation pattern generated by an array of radiating elements may be improved in many cases. However, when the amount of electronic downtilt becomes large (e.g., greater than 10°), then azimuth HPBW of the generated radiation pattern may shrink considerably. In some applications, this may be advantageous, while in other applications, this shrinking of the azimuth HPBW may be less desirable. If the radiating elements are mechanically downtilted (e.g., downtilted 8-10° from the horizon) and the resulting radiation pattern is electronically uptilted to compensate for the mechanical downtilt (e.g., electronically uptilted) 8-10°), then any electronic downtilt applied by a cellular operator in order to reduce the coverage area of the antenna will reduce the amount of electronic uptilt applied as opposed to increasing the amount of electronic uptilt. For example, if the radiating elements of a linear array are mechanically downtilted 9° and the cellular operator desires a 2° electronic downtilt to reduce the coverage area, then the electronic uptilt would be set at 7°. Since the operator-added electronic downtilt acts to reduce the amount of electronic uptilt applied, and the azimuth HPBW of the generated radiation pattern may thus get larger as opposed to smaller.

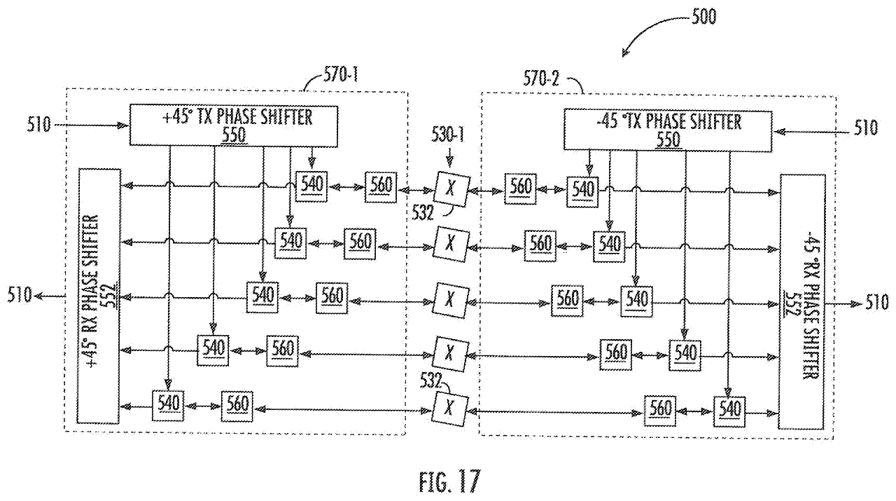

Of course, too much broadening of the azimuth HPBW is also generally undesirable, and hence applications where the combination of mechanical downtilt and electronic uptilt will improve the radiation pattern are generally more limited than the reverse case. However, one application where such an approach may be beneficial is for base station antennas that do not have remote electronic downtilt capabilities. With these antennas, the radiating elements could be mechanically downtilted and a generally offsetting electronic uptilt could be hardwired into the feed network for the linear array. Such an antenna is schematically illustrated in FIG. 17, which is a schematic block diagram of a base station antenna 500 that has a linear array 530-1 of slant −45°/+45° cross-polarized dipole radiating elements 532 that are mechanically downtilted. FIG. 17 shows the electrical connections between the input/output ports 510 of antenna 500 and the linear array 530-1. As shown in FIG. 17, the base station antenna 500 includes feed networks 570-1, 570-2 that connect the input/output ports 510 to the linear array 530-1. Each feed network includes duplexers 540, power splitters 550, power combiners 552 and fixed electronic delay elements 560. The feed networks 570-1, 570-2 may operate identically to the feed networks 270-1, 270-2 discussed above with reference to FIG. 14, except that the adjustable phase shifters with integrated power divider/combiners 250 included in the feed networks 270-1, 270-2 of FIG. 14 are replaced with power dividers 550 and power combiners 552 in feed networks 570-1, 570-2 so that the ability to adjust the amount of electronic adjustment to the tilt angle of the radiation pattern is removed in base station antenna 500. Further discussion of the operation of the feed networks 570-1, 570-2 will be omitted in light of the discussion above. As is also schematically shown in FIG. 17, the individual radiating elements 532 of linear array 530-1 are mechanically downtilted.

It should be noted that the electronic uptilt need not perfectly match the mechanical downtilt. For example, the radiating elements 532 could have an 8° mechanical downtilt and the fixed delay units 560 could apply a 6° electronic uptilt in an example embodiment. In some cases, this may provide improved performance as compared to linear arrays that have radiating elements that have no mechanical tilt. One potential application where mechanically downtilted linear arrays having a fixed electronic uptilt may be desirable is in three-sector small cell base station antennas that use three linear arrays of radiating elements that have boresight azimuth pointing directions that are offset by 120° to provide omnidirectional coverage. Such antennas often do not include remote electronic downtilt capabilities in order to reduce the size and the cost of the antenna. In some cases, mechanically downtilting the radiating elements while providing a fixed electronic uptilt may provide improved radiation patterns.

While example embodiments of the present invention are described above, it will be appreciated that these example embodiments are provided to show example implementations and are not intended to limit the scope of the present invention as described in the appended claims. Thus, for example, while the example base station antennas described above have certain arrangements of arrays it will be appreciated that the techniques described herein may be used on any base station antennas having any configuration of arrays. Similarly, while the base station antenna 200 described above performs duplexing in the antenna, it will be appreciated that in other embodiments the duplexing may be performed in the radio. Likewise, while the base station antenna 200 only includes linear arrays of radiating elements, it will be appreciated that the techniques described herein may also be used with planar arrays of radiating elements.

The present invention has been described above with reference to the accompanying drawings. The invention is not limited to the illustrated embodiments; rather, these embodiments are intended to fully and completely disclose the invention to those skilled in this art. In the drawings, like numbers refer to like elements throughout. Thicknesses and dimensions of some components may be exaggerated for clarity.

Spatially relative terms, such as “under”, “below”, “lower”, “over”, “upper”, “top”, “bottom” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “under” or “beneath” other elements or features would then be oriented “over” the other elements or features. Thus, the exemplary term “under” can encompass both an orientation of over and under. The device may be otherwise oriented (rotated 90 degrees or at other orientations) and the spatially relative descriptors used herein interpreted accordingly.

Herein, the terms “attached”, “connected”, “interconnected”, “contacting”, “mounted” and the like can mean either direct or indirect attachment or contact between elements, unless stated otherwise.

Well-known functions or constructions may not be described in detail for brevity and/or clarity. As used herein the expression “and/or” includes any and all combinations of one or more of the associated listed items.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises”, “comprising”, “includes” and/or “including” when used in this specification, specify the presence of stated features, operations, elements, and/or components, but do not preclude the presence or addition of one or more other features, operations, elements, components, and/or groups thereof.

Components of the various embodiments of the present invention discussed above may be combined to provide additional embodiments. Thus, it will be appreciated that while a component or element may be discussed with reference to one embodiment by way of example above, that component or element may be added to any of the other embodiments.

1. A base station antenna, comprising:
a reflector;
a first radio frequency (“RF”) port;
an array of radiating elements, each of the radiating elements mounted to extend forwardly from the reflector and mechanically uptilted with respect to the reflector; and
a feed network coupled between the first RF port and the array of radiating elements, the feed network including a plurality of delay elements that are configured to impart a fixed electronic downtilt to a radiation pattern generated by the array of radiating elements in response to an RF signal input at the first RF port.

2. The base station antenna of claim 1, wherein the array of radiating elements is configured so that an elevation angle of a mechanical boresight pointing direction of the array is greater than 1° when the base station antenna is mounted for use.

3. (canceled)

4. The base station antenna of claim 1, wherein each radiating element is mechanically uptilted to a degree so that in the absence of any electronic downtilt, a maximum gain of the radiation pattern at the horizon is at least 7 dB less than a maximum gain of the radiation pattern generated by the array of radiating elements.

5. The base station antenna of claim 1, wherein each radiating element includes a director, and wherein the directors are positioned to be parallel to the reflector.

6. (canceled)

7. The base station antenna of claim 1, wherein each radiating element has a mechanical uptilt with respect to the reflector of at least 8 degrees.

8. The base station antenna of claim 1, wherein the absolute value of an angle of the fixed electronic downtilt is within two degrees of an absolute value of the elevation angle of a mechanical boresight pointing direction of the array of radiating elements.

9. The base station antenna of claim 1, wherein the absolute value of an angle of the fixed electronic downtilt exceeds an absolute value of the elevation angle of a mechanical boresight pointing direction of the array of radiating elements.

10. (canceled)

11. The base station antenna of claim 1, wherein the delay elements comprise transmission line segments having pre-selected lengths that are selected to impart a phase taper to the sub-components of RF signals provided to respective sub-arrays of the radiating elements.

12. The base station antenna of claim 1, wherein the array of radiating elements is configured so that an elevation angle of a mechanical boresight pointing direction of the array is greater than 4° when the base station antenna is mounted for use.

13. A base station antenna, comprising:
a reflector;
a first radio frequency (“RF”) port;
an array of radiating elements, each of the radiating elements mounted to extend forwardly from the reflector;
a feed network coupled between the first RF port and the array of radiating elements;
wherein each radiating element is mechanically uptilted so that an elevation angle of a mechanical boresight pointing direction of the array of radiating elements has a first value that is greater than 0° when the base station antenna is mounted for use,
wherein the feed network is configured to impart a fixed electronic downtilt to a radiation pattern generated by the array of radiating elements in response to an RF signal input at the first RF port, wherein the fixed electronic downtilt lowers the elevation angle of the mechanical boresight pointing direction of the radiation pattern by a second value that is at least half the first value.

14. The base station antenna of claim 13, wherein the first value differs from the second value by no more than 2°.

15. (canceled)

16. The base station antenna of claim 13, wherein feed stalks of each radiating element are mounted to extend perpendicular to the reflector, and a portion of the reflector that is immediately behind a first of the radiating elements is mounted at an angle of at least 3 degrees with respect to a vertical axis of the base station antenna.

17. The base station antenna of claim 13, wherein each of the radiating elements is mechanically uptilted with respect to the reflector

18. The base station antenna of claim 17, wherein each radiating element includes a director, and wherein the directors are positioned to be parallel to the reflector.

19. The base station antenna of claim 13, wherein the feed network further includes an adjustable electronic downtilt unit.

20. The base station antenna of claim 13, wherein each radiating element has a mechanical uptilt of at least 4 degrees.

21-22. (canceled)

23. The base station antenna of claim 13, wherein each radiating element is mechanically uptilted to a degree so that in the absence of any electronic downtilt, a maximum gain of the radiation pattern at the horizon is at least 7 dB less than a maximum gain of the radiation pattern generated by the array of radiating elements.

24. A base station antenna, comprising:
a reflector;
a first radio frequency (“RF”) port;
an array of radiating elements, each of the radiating elements mounted to extend forwardly from the reflector and mechanically downtilted with respect to the reflector; and
a feed network coupled between the first RF port and the array of radiating elements, the feed network including a plurality of delay elements that are configured to impart a fixed electronic uptilt to a radiation pattern generated by the array of radiating elements in response to an RF signal input at the first RF port.

25. The base station antenna of claim 24, wherein each radiating element has a mechanical downtilt with respect to the reflector of at least 4 degrees.

26. The base station antenna of claim 24, wherein the absolute value of an angle of the fixed electronic uptilt is within two degrees of an absolute value of the elevation angle of a mechanical boresight pointing direction of the array of radiating elements.

27-28. (canceled)
